(19) United States
(12) Patent Application Publication
(10) Pub. No.: US 2026/0159332 A1
(43) Pub. Date: Jun. 11, 2026

(54) NAIL COIL REMEDIATION SYSTEMS AND METHODS

(71) Applicant: Purdue Research Foundation, West Lafayette, IN (US)

(72) Inventors: Alan A. Hopf, Jasper, IN (US); Malik Hagverdiyev, Baku (AZ); Mohamad Raed Aldawood, Riyadh (SA); Samuel Ari Rosoff, Huntingdon Valley, PA (US); Teodoro Greenbaum Bagnoli, Redmond, WA (US); Zachary Connor Little, Floyds Knobs, IN (US)

(73) Assignee: Purdue Research Foundation, West Lafayette, IN (US)

(21) Appl. No.: 19/406,847

(22) Filed: Dec. 2, 2025

Related U.S. Application Data
(60) Provisional application No. 63/729,374, filed on Dec. 7, 2024.

(51) Int. Cl. B65G 47/24; F16B 15/08

(52) U.S. Cl. CPC B65G 47/24; F16B 15/08

(57) ABSTRACT

A nail coil remediation apparatus includes a roller assembly, a rotary holding shaft, and a nail channel assembly. The roller assembly includes sequentially aligned stages, at least one stage interfacing with at least one motor that powers the roller assembly. The stages include an aligning stage that includes a first roller and a helical gear member having multiple teeth, and a straightening stage including a second roller. The rotary holding shaft is configured to support the nail coil and selectively transfer the nail coil to and from the roller assembly. The nail channel assembly includes a slot configured to receive the nail coil from rotary holding shaft and selectively transfer the nail coil through the roller assembly.

### CROSS-REFERENCE TO RELATED APPLICATIONS

This application is related to and claims the priority benefit of U.S. Provisional Application No. 63/729,374 filed Dec. 7, 2024, the entirety of which is hereby incorporated by reference.

### TECHNICAL FIELD

The present application relates to handheld nailing tools, and specifically to devices which return misaligned and damaged nail coils back to usable form.

### BACKGROUND

A nail coil is a spiral arrangement of nails held together by thin wire, typically used in pneumatic or electric coil nailers for rapid and efficient fastening in a construction application. The nails are arranged in a compact, circular shape, allowing for a large number of nails to be stored and fed into a nail gun without frequent reloading. Nail coils are commonly used for tasks such as framing, roofing, and siding. A common issue with nail coils is that they can become tangled and pinched out of shape especially if not handled or stored properly. When the coil tangles, it disrupts the smooth feeding of nails into the nailer, causing jams or misfires. Often, these tangled coils are discarded before they are fully used, resulting in wasted materials and added costs for workers or contractors. Thus, the inventors of the present disclosure have endeavored to provide solutions to this issue.

### SUMMARY

This summary is provided to introduce a variety of concepts in a simplified form that are further disclosed in the detailed description of the embodiments. This summary is not intended to identify key or essential inventive concepts of the claimed subject matter, nor is it intended to determine the scope of the claimed subject matter.

In one aspect, variations of the disclosed nail coil remediation apparatus may include a rotary holding shaft and helical gear member positioned within a frame structure, dual-direction rotational capabilities for bidirectional processing, and an integrated nail channel assembly configured to provide complete nail coil remediation through mechanical alignment processes rather than manual realignment procedures. The remediation mechanisms enable controlled nail positioning, automated alignment correction through helical gear engagement with individual nails, and operational efficiency through bidirectional processing, providing reliable operation while eliminating the wasteful disposal practices that characterize damaged nail coil management in the construction industry.

In one aspect, variations of the disclosed nail coil remediation system may include an integrated configuration with frame-supported components, motor-driven roller assemblies, and gear-based alignment technologies. The system incorporates a rotary holding shaft with bidirectional rotation capabilities, nail channel assemblies with slot configurations for guided nail processing, and roller assemblies with gear members configured to remediate nail alignment during automated processing procedures. The integrated design eliminates the need for manual nail realignment procedures and wasteful coil disposal while providing comprehensive remediation functionality with multi-stage roller processing and bidirectional operation in a unified system.

In one aspect, variations of the disclosed nail coil remediation device may include positioning gear alignment members and engaging roller mechanisms. The device involves automatic nail guidance through helical tooth engagement using mechanical force application while correcting nail angular alignment and spacing through controlled advancement past the gear alignment member. The operation process enables shaft rotation for nail advancement, automated nail alignment through gear tooth spacing intervals, creating complete remediation functionality that reduces waste from damaged nail coils while maintaining original equipment manufacturer specifications for angular orientation and spacing between nails.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a schematic diagram of an exemplary nail coil remediation system;

FIG. 2 depicts a side elevational view of the nail coil remediation system of FIG. 1;

FIG. 3 depicts a top plan view of the nail coil remediation system of FIG. 1;

FIG. 4 depicts a schematic diagram of one exemplary roller assembly of the nail coil remediation system of FIG. 1;

FIG. 5 depicts a side view of the roller assembly of FIG. 4;

FIG. 6 depicts a front elevational view of the roller assembly of FIG. 4;

FIG. 7 depicts a rear elevational view of the roller assembly of FIG. 4;

FIG. 8 depicts a top plan view of the roller assembly of FIG. 4;

FIG. 9 depicts a bottom plan view of the roller assembly of FIG. 4;

FIG. 10 depicts a schematic diagram of one exemplary gear alignment member of the roller assembly of FIG. 4;

FIG. 11 depicts a top plan view of the gear alignment member of FIG. 10;

FIG. 12 depicts a schematic diagram of one exemplary nail channel assembly of the nail coil remediation system of FIG. 1;

FIG. 13 depicts a top plan view of the nail channel assembly of FIG. 12;

FIG. 14 depicts a cross-sectional view of a portion of the nail channel assembly of FIG. 12, shown with a portion of a nail coil passing through the slot; and

FIG. 15 depicts a schematic diagram of a portion of the nail coil remediation system of FIG. 1, showing an enlarged view of the nail coil removal plate.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION OF THE ILLUSTRATED EMBODIMENTS

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

For clarity and consistency, the same reference numerals will be used throughout the detailed description to refer to the same or corresponding components across the various figures. When a particular component is discussed while referring to a figure different from the one in which the component first appears, the reference numeral and original figure will be cited for clarity.

Terms such as “inner,” “outer,” “first,” “second,” “upstream,” and “downstream” may be used in the following description for clarity with respect to the orientation of components as shown in the figures. These terms are not intended to be limiting and may be interpreted relative to the position or orientation of the nail coil remediation system in actual use, which may vary.

Unless otherwise specified, the singular forms “a,” “an,” and “the” include plural referents. Components may be described functionally rather than structurally where appropriate for clarity. Any features or configurations disclosed as being optional or alternative may be implemented individually or in any suitable combination, as would be understood by one of ordinary skill in the art.

The disclosed nail coil remediation apparatus may include frame materials formed from metallic, polymeric, or composite materials that provide structural integrity while maintaining durability and stability requirements compared to conventional manual nail realignment tools. The apparatus may be configured to eliminate manual nail realignment procedures through integrated helical gear engagement while maintaining controlled bidirectional processing functionality during normal operational cycles. In some embodiments, alternative material formulations such as steel, aluminum, or reinforced polymer composites may be used to achieve similar strength characteristics and operational reliability properties.

The nail coil remediation apparatus may comprise rotary holding shaft elements and helical gear alignment components that enable controlled nail repositioning without requiring manual manipulation procedures. The alignment mechanisms may be configured to provide controlled nail spacing correction and angular adjustment through helical tooth engagement, eliminating the time-consuming and waste-generating characteristics typically associated with damaged nail coil disposal practices. The rotary holding shaft elements may be positioned to support nail coils during unwinding and rewinding cycles and may feature magnetic material characteristics to provide nail coil retention during rotation operations. The helical gear components may be configured to engage exclusively with individual nails of the coil, creating precise alignment corrections that restore original equipment manufacturer specifications while permitting controlled processing without manual intervention.

The nail coil remediation apparatus may also include integrated nail channel assemblies positioned to guide nail coils through the processing system, dimensioned to provide head-constraining capabilities and uniform nail processing characteristics for controlled remediation, consistent operation, or multi-coil processing requirements. These integrated components may provide reliable guidance surfaces while eliminating the alignment inconsistencies and processing variations associated with manual realignment attempts and improvised repair methods. The nail channel components may be optimized to accommodate various nail coil configurations while maintaining the structural integrity and operational characteristics of the overall assembly.

The nail coil remediation apparatus may be configured to enable bidirectional processing during operation, maintaining proper nail alignment correction through forward and reverse passes without requiring specialized tools or extensive training procedures. The apparatus may be configured to engage through rotational direction reversal and processing verification, providing flexibility in construction applications and operational configurations. The bidirectional processing capabilities may be configured to achieve comprehensive alignment correction under various damage conditions while permitting consistent operational characteristics and repeated processing without degradation of the remediation effectiveness.

The nail coil remediation apparatus may include multiple drive configurations designed for different operational environments, including electric motor systems for shop applications and manual hand crank mechanisms for field use situations. Each drive type may incorporate the same alignment principles while providing specialized power delivery configurations to address specific operational requirements.

In use, construction workers or roofing contractors may position damaged nail coils on the rotary holding shaft according to coil configuration requirements and engage the drive mechanisms to create controlled remediation functionality without extensive manual manipulation considerations. The apparatus may be operated by mounting the damaged coil on the shaft and activating the rotational drive to pass the coil through the roller assembly and helical gear member. The helical gear teeth engage with individual nails through controlled spacing, creating alignment corrections that restore original equipment manufacturer angular orientation and spacing specifications during normal processing cycles. The remediation mechanism operates through bidirectional rotation rather than single-pass operation, eliminating processing limitations and enabling consistent performance throughout the remediation cycle. Bidirectional rotation additionally allows the nail coil to be returned to the operator in a fully rewound condition.

A residential roofing company may utilize the nail coil remediation apparatus to address material waste challenges commonly experienced when damaged coils are discarded before complete use. The elimination of manual realignment attempts prevents time losses and inconsistent results resulting from improvised repair techniques utilized during active construction projects. The consistent remediation characteristics function across multiple nail coil types, improving material efficiency during roofing operations and reducing waste costs associated with damaged coil disposal practices.

A commercial construction site working with large-scale framing operations may benefit from the apparatus's ability to maintain consistent nail coil availability during various construction applications such as wall framing, roof decking, and sheathing installation procedures. The automated remediation technology maintains operational consistency without requiring manual skills that could restrict construction flexibility, while the bidirectional processing eliminates the material limitations construction crews often face when managing damaged nail coils in time-sensitive building schedules.

A tool rental facility may employ the nail coil remediation apparatus when servicing pneumatic nailer equipment and managing customer-returned damaged coils that would otherwise contribute to facility waste streams. The consistent operational characteristics reduce material handling complexity during inventory management, while the reliable remediation ensures nail coils meet original equipment manufacturer specifications for safe use in rental nailer equipment. The elimination of manual realignment requirements prevents facility personnel from experiencing processing variations during high-volume coil management scenarios, improving material recovery consistency with facility operational protocols.

It should be noted that the use cases described above are merely illustrative examples of how the nail coil remediation apparatus may be utilized, and the practical applications are not limited to these specific scenarios. The helical gear alignment design and bidirectional processing features make the apparatus suitable for a wide variety of construction and manufacturing applications where material efficiency, waste reduction, or nail coil restoration requirements provide advantages over conventional disposal practices.

The disclosed nail coil remediation apparatus provides a device that offers an automated alternative to conventional disposal approaches configured to address the material waste challenges of damaged nail coil management practices. By incorporating helical gear alignment technology, integrated bidirectional processing components, and rotary shaft mounting systems, the device enables controlled nail coil remediation functionality without manual realignment dependencies while eliminating the material waste inefficiencies associated with damaged coil disposal techniques. Unlike conventional practices that rely on disposal and replacement creating material waste across construction operations, this configuration provides consistent remediation through mechanical processes and incorporates automated design elements to improve material efficiency, enabling nail coil restoration to proceed effectively in a variety of residential, commercial, industrial, and rental facility applications.

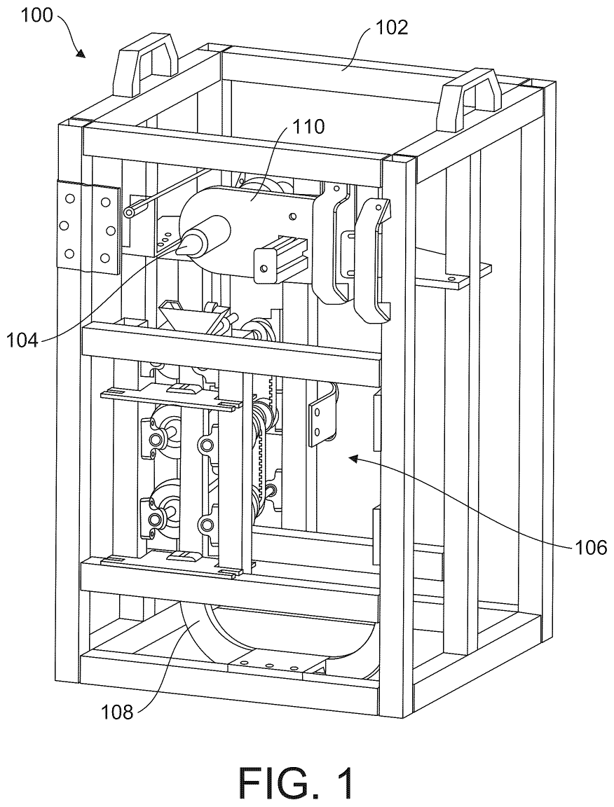

FIG. 1 illustrates an isometric view of a nail coil remediation apparatus 100 according to one embodiment of the disclosed invention. The nail coil remediation apparatus 100 represents a system designed for remediating damaged nail coils that have become bent, twisted, or misaligned during construction operations, eliminating the need for wasteful disposal practices.

The nail coil remediation apparatus 100 comprises a frame 102 that defines the primary structural support for the system components. The frame 102 provides the main support structure for internal components and subassemblies while serving as the stable platform during nail coil processing operations. The frame 102 extends to accommodate the rotary holding shaft 104, roller assembly 106, and nail channel assembly 108 in proper spatial relationship to enable effective nail coil remediation. The frame 102 maintains a stable configuration that enables secure mounting to work surfaces or benchtops while providing sufficient structural rigidity to withstand operational forces during bidirectional nail coil processing cycles. The frame 102 may be formed from metallic materials including steel or aluminum that provide durability and dimensional stability during repeated processing operations, or may comprise reinforced polymer composites that reduce overall system weight while maintaining adequate structural support characteristics.

The nail coil remediation apparatus 100 further comprises a rotary holding shaft 104 that integrates with the frame 102 to provide the mounting surface and rotational drive system for damaged nail coils. The rotary holding shaft 104 positions within the frame 102 in a configuration that permits rotational movement about its longitudinal axis while maintaining proper alignment with the nail channel assembly 108. The rotary holding shaft 104 extends along a horizontal axis to accommodate nail coils in their wound spiral configuration, providing a cylindrical mounting surface around which damaged coils may be positioned. The rotary holding shaft 104 connects operatively to drive mechanisms that enable bidirectional rotation, allowing the shaft 104 to rotate in a first direction to unwind nail coils and advance them through processing stages, and to rotate in a second direction opposite the first direction to rewind processed nail coils after remediation operations complete.

The rotary holding shaft 104 functions to support nail coils during unwinding operations while controlling the rate at which individual nails feed into the nail channel assembly 108. The rotary holding shaft 104 provides consistent rotational motion that maintains proper tension on the nail coil as individual nails separate from the wound configuration and enter the processing path. The rotary holding shaft 104 enables controlled bidirectional processing by reversing rotational direction after forward processing completes, allowing the nail coil to pass through the roller assembly 106 a second time in the opposite direction to achieve comprehensive alignment correction. This bidirectional capability ensures that each nail of the coil undergoes remediation twice, once during forward advancement and once during reverse passage, achieving alignment correction to original equipment manufacturer (OEM) specifications, as well as ensuring the coil is rewound properly. The holding shaft additionally features a tapered cone on the front end to assist with properly centering and guiding the damaged nail coil on the rotary holding shaft as it is mounted. A magnetic ring is integrated into the rotary holding shaft behind the tapered cone, holding the nail coil in place on the shaft as it is rotated throughout the remediation process.

The nail coil remediation apparatus 100 comprises a roller assembly 106 positioned adjacent to the nail channel assembly 108 to provide the mechanical alignment correction mechanisms. The roller assembly 106 integrates with the frame 102 through mounting structures that maintain precise positioning relative to the nail channel assembly 108 during processing operations. The roller assembly 106 includes components configured to engage individual nails of the nail coil as they pass through the assembly 106, applying corrective forces that restore proper angular orientation and spacing between consecutive nails. The roller assembly 106 operates continuously during both forward and reverse rotational cycles of the rotary holding shaft 104, ensuring each nail receives alignment correction during bidirectional passage through the apparatus 100.

The nail coil remediation apparatus 100 further comprises a nail channel assembly 108 that guides nail coils from the rotary holding shaft 104 through the roller assembly 106 while constraining nail positioning for uniform processing. The nail channel assembly 108 positions between the rotary holding shaft 104 and the roller assembly 106 to provide a controlled pathway that directs individual nails into proper engagement with alignment mechanisms. The nail channel assembly 108 includes a slot configured to receive nail heads while preventing nail shafts from entering, ensuring each nail maintains consistent orientation as it advances through the apparatus 100. The nail channel assembly 108 functions to align nail heads into a common plane, eliminating variations in nail positioning that could prevent uniform alignment correction by the roller assembly 106.

The frame 102, rotary holding shaft 104, roller assembly 106, and nail channel assembly 108 work collectively to provide automated nail coil remediation functionality. The frame 102 supports and positions the rotary holding shaft 104 and nail channel assembly 108 in proper spatial relationship, while the rotary holding shaft 104 controls nail coil advancement through the nail channel assembly 108 toward the roller assembly 106. The nail channel assembly 108 guides and constrains nail positioning to enable consistent engagement with the roller assembly 106, which applies corrective forces to restore OEM angular orientation and spacing specifications. The integrated configuration enables damaged nail coils to undergo comprehensive remediation through bidirectional processing, reducing material waste and eliminating the costs associated with discarding partially used coils.

The nail coil remediation apparatus 100 may optionally comprise a removal plate 110 that facilitates extraction of remediated nail coils from the rotary holding shaft 104. The removal plate 110 positions on the rotary holding shaft 104 beneath the wound nail coil, providing a support surface during winding and unwinding operations. The removal plate 110 includes an opening through which the rotary holding shaft 104 extends, enabling the plate 110 to slide along the shaft 104 during nail coil loading and removal operations. The removal plate 110 may include a handle or gripping feature that enables users to pull the plate 110 and attached nail coil off the rotary holding shaft 104 after remediation completes, simplifying coil handling, ensuring no damage occurs to the repaired coil, and reducing the time required for sequential processing of multiple damaged coils.

In some embodiments, the frame 102 comprises steel construction with welded joints that provide enhanced rigidity and dimensional stability during high-force processing operations. In some embodiments, the frame 102 comprises aluminum extrusions with bolted connections that reduce system weight for improved portability between job sites. In some embodiments, the frame 102 includes mounting features on its base that enable bolting to workbenches or securing to truck beds for stable operation in various work environments. In some embodiments, the frame 102 incorporates handles or grip surfaces that facilitate manual positioning and transport of the apparatus 100.

In some embodiments, the rotary holding shaft 104 comprises or includes a section of a magnetic material that attracts and secures steel nail coils during winding and unwinding operations, preventing coil slippage during rotation. In some embodiments, the rotary holding shaft 104 includes a textured or knurled surface that increases friction between the shaft 104 and nail coils to maintain positive engagement during processing. In some embodiments, the rotary holding shaft 104 connects to an electric motor that provides controlled rotational speed and directional control through electronic controls. In some embodiments, the rotary holding shaft 104 connects to a hand crank mechanism that enables manual operation without electrical power requirements for field use applications.

In some embodiments, the roller assembly 106 comprises multiple sequential processing stages that progressively correct nail alignment and straighten bent nail shafts through staged engagement. In some embodiments, the roller assembly 106 includes electric motors that drive roller rotation at controlled speeds synchronized with rotary holding shaft 104 rotation. In some embodiments, the roller assembly 106 incorporates belt and pulley drive systems that transmit rotational motion from drive motors to multiple roller components.

In some embodiments, the nail channel assembly 108 comprises low-friction polymer materials including polytetrafluoroethylene (PTFE) or ultra-high-molecular-weight polyethylene (UHMW) that reduce drag forces on advancing nail coils. In some embodiments, the nail channel assembly 108 comprises metal construction with polished interior surfaces that provide durable low-friction characteristics suitable for high-volume processing operations. In some embodiments, the nail channel assembly 108 includes adjustable positioning features that enable accommodation of different nail coil configurations or sizes.

In some embodiments, the nail coil remediation apparatus 100 achieves nail coil circularity improvement from approximately 64% before processing to approximately 90% after bidirectional processing through the roller assembly 106. In some embodiments, the apparatus 100 processes nail coils with angular tolerance correction to within plus or minus 1 degree of OEM specifications. In some embodiments, the apparatus 100 completes processing cycles in under 8 seconds per coil for typical construction-grade nail coil configurations.

IG. 2 illustrates a side elevational view of the nail coil remediation apparatus 100 of FIG. 1 according to the same embodiment shown in FIG. 1. The side elevational view reveals the vertical spatial relationships between components and demonstrates the accessibility features of the apparatus 100 during operation.

The side elevational view shows the frame 102 extending vertically to provide support for the rotary holding shaft 104 positioned in the upper portion of the apparatus 100 and the roller assembly 106 positioned in the lower portion of the apparatus 100. The vertical arrangement enables gravity-assisted nail coil feeding during unwinding operations, as damaged nail coils positioned on the rotary holding shaft 104 naturally descend through the nail channel assembly 108 toward the roller assembly 106 during rotation. The frame 102 maintains sufficient vertical clearance between the rotary holding shaft 104 and the roller assembly 106 to accommodate nail channel assembly 108 positioning while permitting nail coils to traverse the processing path without interference from frame components.

The removal plate 110 positions at the top of the frame 102 adjacent to the rotary holding shaft 104, providing convenient access for coil loading and removal operations. The elevated positioning of the removal plate 110 enables users to grasp the plate 110 and slide remediated nail coils off the rotary holding shaft 104 without bending or reaching into confined spaces within the frame 102. The handle portion of the removal plate 110 extends above the frame 102 to provide ergonomic gripping surfaces during removal operations.

The side elevational view demonstrates the roller assembly 106 positioning within the lower portion of the frame 102, with multiple roller stages visible extending horizontally across the apparatus 100 width. The roller assembly 106 integrates with the nail channel assembly 108 to receive nail coils advancing downward from the rotary holding shaft 104, with the vertical spacing between stages accommodating nail coil passage during bidirectional processing cycles.

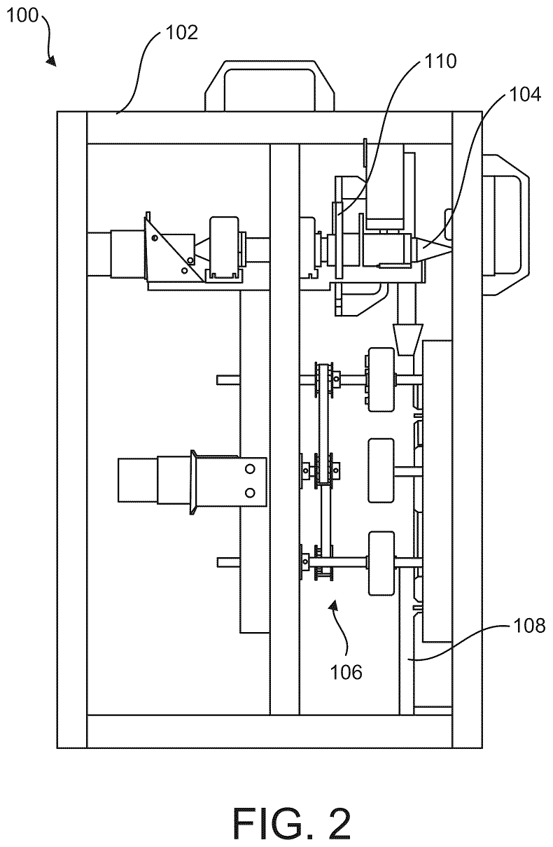

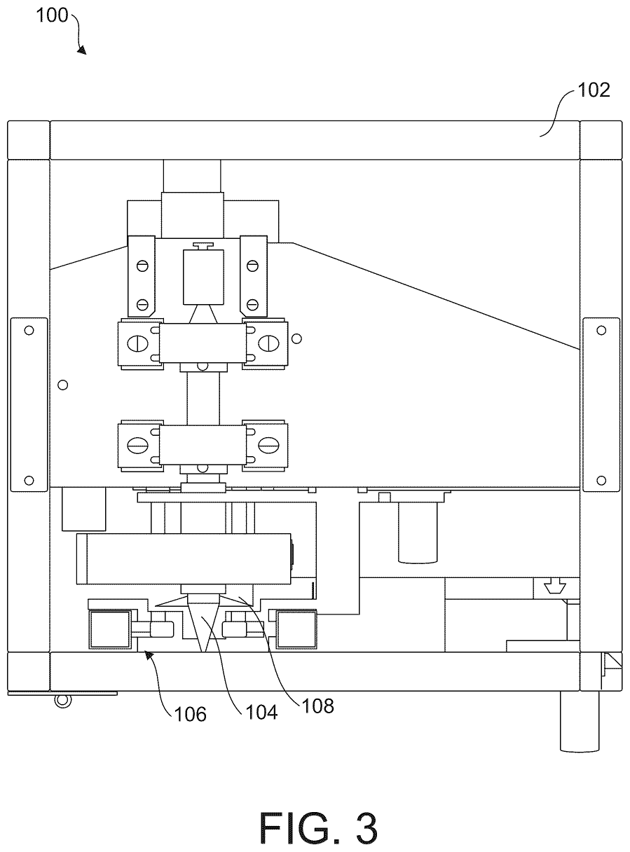

FIG. 3 illustrates a top plan view of the nail coil remediation apparatus 100 of FIG. 1 according to the same embodiment shown in FIGS. 1 and 2. The top plan view reveals the horizontal spatial relationships between components and demonstrates the frame structure supporting the internal mechanisms.

The top plan view shows the frame 102 defining a rectangular perimeter that encloses the rotary holding shaft 104, roller assembly 106, and nail channel assembly 108 within a protected working area. The frame 102 comprises four corner members and connecting members that form a rigid boundary while maintaining open interior space for component operation. The rectangular configuration provides balanced support across all sides of the apparatus 100 while enabling access to internal components from multiple directions during loading, processing, and removal operations.

The rotary holding shaft 104 extends horizontally across the width of the frame 102 near one end, with shaft ends supported by frame members to enable rotational movement about the longitudinal axis. The horizontal orientation visible in the top plan view demonstrates the shaft's 104 capability to support wound nail coils along its length while maintaining proper alignment with the nail channel assembly 108 positioned below.

The roller assembly 106 positioning within frame 102 shows the horizontal arrangement of multiple processing stages extending parallel to the rotary holding shaft 104. The parallel configuration ensures nail coils advancing from the rotary holding shaft 104 encounter each processing stage sequentially during forward and reverse passage through the apparatus 100. The roller assembly 106 components remain contained within the frame 102 boundaries to provide protection from external damage while maintaining accessibility for maintenance operations.

The nail channel assembly 108 extends between the rotary holding shaft 104 and the roller assembly 106, providing the guided pathway visible in the top plan view that directs nail coils from the mounting position on the shaft 104 toward the alignment correction mechanisms of the roller assembly 106. The channel assembly 108 curvature accommodates the transition from the cylindrical surface of the rotary holding shaft 104 to the linear processing path through the roller assembly 106.

In some embodiments, the frame 102 comprises welded steel construction with reinforcement members at corners to enhance rigidity during high-force alignment operations. In some embodiments, the frame 102 includes mounting feet or leveling adjustments on the base to ensure stable positioning on uneven work surfaces. In some embodiments, the vertical spacing between the rotary holding shaft 104 and roller assembly 106 accommodates nail coil diameters ranging from approximately 50 millimeters to approximately 200 millimeters.

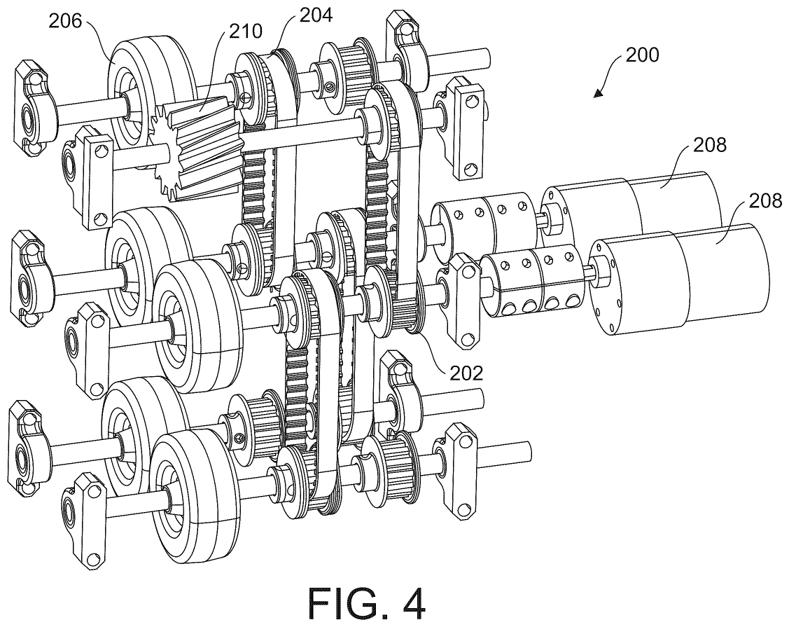

FIG. 4 illustrates a schematic diagram of one exemplary roller assembly 200 of the nail coil remediation system 100 of FIG. 1. The roller assembly 200 represents a specific embodiment that performs the functions of roller assembly 106 described in FIGS. 1-3. The schematic diagram reveals the internal drive mechanisms and multi-stage processing configuration that enable automated nail alignment correction.

The roller assembly 200 comprises toothed pulleys 202 that provide rotational drive transfer between components. The toothed pulleys 202 position on rotational shafts extending through the assembly 200 to enable synchronized motion transfer across multiple processing stages. The toothed pulleys 202 include circumferential teeth that engage with corresponding teeth on belts 204 to prevent slippage during power transmission. The toothed configuration ensures positive engagement that maintains consistent rotational speeds across all driven components regardless of processing loads encountered during nail coil advancement.

The roller assembly 200 further comprises belts 204 that interconnect the toothed pulleys 202 to transmit rotational motion between stages. The belts 204 extend between toothed pulleys 202 positioned at different elevations within the assembly 200, creating mechanical linkages that synchronize component rotation. The belts 204 comprise flexible materials that accommodate the spacing between pulleys 202 while maintaining sufficient tensile strength to transmit drive forces without stretching or deformation during operation. The belt 204 routing creates a coordinated drive system where single motor input produces synchronized rotation across multiple processing stages.

The roller assembly 200 comprises rollers 206 that engage nail coils during processing operations. The rollers 206 position within multiple sequential stages of the assembly 200, with each stage comprising one or more rollers 206 arranged to contact nail coils from different angles. The rollers 206 provide cylindrical surfaces that rotate about horizontal axes to guide nail coils through the assembly 200 while applying controlled pressure. The rollers 206 in different stages serve distinct functions, with some rollers 206 working in conjunction with the gear alignment member 210 to force individual nails into tooth spaces, while other rollers 206 provide straightening forces to correct bent nail shafts.

The roller assembly 200 comprises motors 208 that provide rotational power to drive the assembly 200 components. The motors 208 connect operatively to toothed pulleys 202 through direct shaft coupling or additional drive mechanisms, with motor 208 rotation transmitted through the belt 204 and pulley 202 system to drive multiple rollers 206 simultaneously. The motors 208 enable bidirectional operation, rotating in a first direction to advance nail coils through the assembly 200 during forward processing, and rotating in a second direction opposite the first direction to draw nail coils back through the assembly 200 during reverse processing. The motors 208 may comprise electric motors that receive power from external sources and respond to control signals that govern rotational speed and direction.

The roller assembly 200 further comprises a gear alignment member 210 positioned within one stage of the multi-stage configuration. The gear alignment member 210 provides the primary alignment correction mechanism that restores nail angular orientation and spacing to original equipment manufacturer specifications. The gear alignment member 210 comprises a cylindrical body with helical teeth extending from its surface, creating spiral grooves that receive individual nails as the nail coil passes through the assembly 200. The gear alignment member 210 positions adjacent to at least one roller 206, with the roller 206 forcing individual nails into the spaces between consecutive teeth of the gear alignment member 210 as the nail coil advances. The gear alignment member 210 functions as the helical gear member recited in the claims, with its tooth spacing and helical angle corresponding to OEM specifications for nail coil construction.

The schematic diagram shows the roller assembly 200 comprising three sequential processing stages arranged vertically. The first stage includes the gear alignment member 210 and at least one roller 206 that work collectively to correct nail angular alignment and spacing. The second and third stages each include one or more rollers 206 that provide additional straightening forces to correct bent nail shafts and flatten twisted nails into linear configurations. The multi-stage arrangement enables progressive correction of different deformation types, with the gear alignment member 210 addressing angular and spacing errors while downstream rollers 206 address shaft straightness.

The toothed pulleys 202, belts 204, rollers 206, and motors 208 work collectively to create an integrated drive system that enables coordinated processing across all stages. The motors 208 provide input rotation that transfers through belts 204 and pulleys 202 to drive all rollers 206 and the gear alignment member 210 at synchronized speeds. The synchronized operation ensures nail coils advance through all processing stages at consistent rates, preventing binding or slack that could cause processing inconsistencies. The bidirectional drive capability enables the complete assembly 200 to reverse operation direction, allowing nail coils to pass through the gear alignment member 210 twice for comprehensive alignment correction.

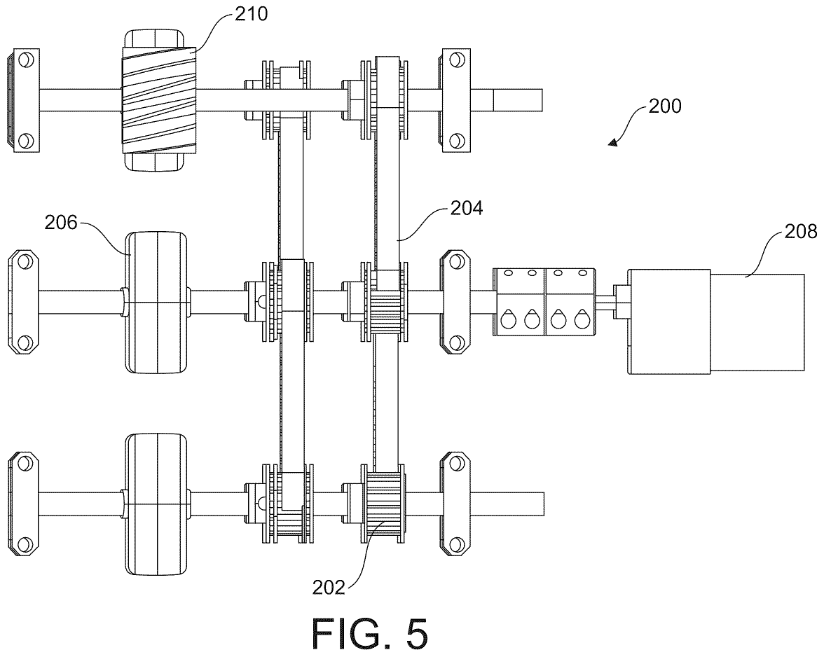

FIG. 5 illustrates a side view of the roller assembly 200 of FIG. 4 according to the same embodiment shown in FIG. 4. The side view reveals the vertical stacking arrangement of the three processing stages and demonstrates the elevation changes between sequential stages.

The side view shows the gear alignment member 210 positioned in the uppermost processing stage, with its helical teeth visible extending from the cylindrical body surface. The gear alignment member 210 positions adjacent to a roller 206 in the first stage, creating the alignment correction mechanism where nail coils pass between the gear alignment member 210 and the roller 206. The elevated positioning of the gear alignment member 210 enables nail coils entering from the rotary holding shaft 104 to engage immediately with the primary alignment correction mechanism before encountering downstream processing stages.

The side view demonstrates the vertical spacing between the first stage containing the gear alignment member 210 and the second and third stages containing additional rollers 206. The vertical arrangement visible in the side view enables gravity-assisted nail coil feeding through the stages, with processed portions of nail coils descending naturally while unprocessed portions remain elevated. The toothed pulleys 202 and belts 204 extend vertically between stages to transmit rotational motion from the motors 208 to all driven components across the elevation changes.

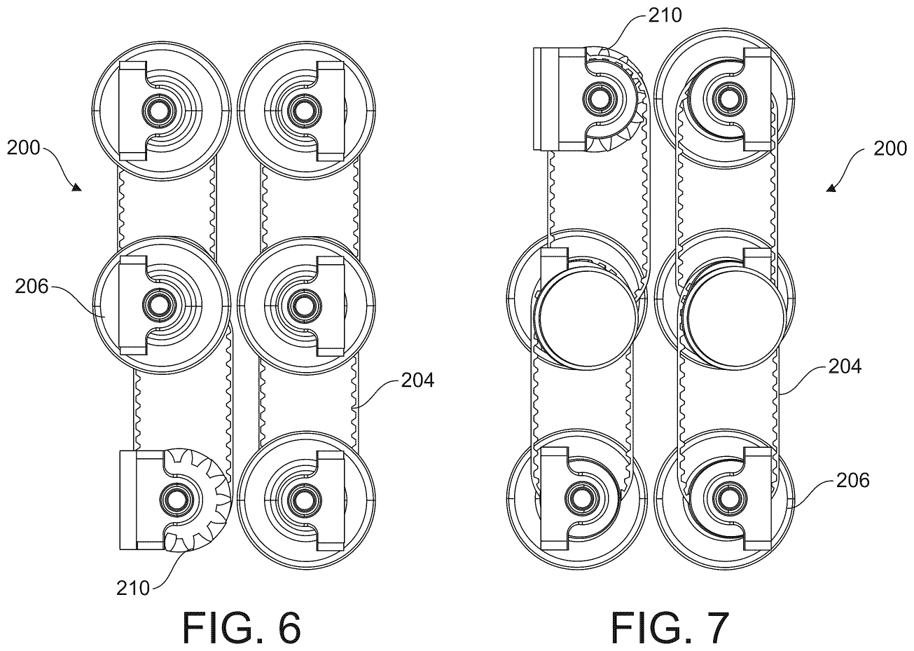

FIG. 6 illustrates a front elevational view of the roller assembly 200 of FIG. 4 according to the same embodiment shown in FIGS. 4 and 5. The front elevational view reveals the horizontal arrangement of rollers 206 across the width of the assembly 200 and shows the belt 204 routing between toothed pulleys 202.

The front elevational view shows multiple rollers 206 positioned side-by-side in horizontal rows within each processing stage. The horizontal arrangement enables simultaneous engagement with nail coils across their width, ensuring uniform processing of all nails in the coil regardless of position. The gear alignment member 210 appears in the bottom portion of the front view, with its position relative to adjacent rollers 206 demonstrating the spacing that accommodates nail coil passage between components.

The belts 204 visible in the front elevational view extend vertically and diagonally between toothed pulleys 202, creating the mechanical linkages that synchronize rotation across horizontally-spaced components. The belt 204 paths maintain tension while accommodating the three-dimensional arrangement of pulleys 202 throughout the assembly 200.

FIG. 7 illustrates a rear elevational view of the roller assembly 200 of FIG. 4 according to the same embodiment shown in FIGS. 4-6. The rear elevational view reveals the positioning of the gear alignment member 210 and demonstrates the support structures that maintain component alignment during operation.

The rear elevational view shows the gear alignment member 210 positioned in the top left location within the first processing stage when viewed from behind the assembly 200. The positioning demonstrates the gear alignment member's 210 integration with the belt 204 and pulley 202 drive system, with mechanical connections visible that enable the gear alignment member 210 to rotate in synchronization with adjacent rollers 206. The rear view reveals mounting brackets and support structures that secure the gear alignment member 210 and rollers 206 to maintain precise spacing during bidirectional processing operations.

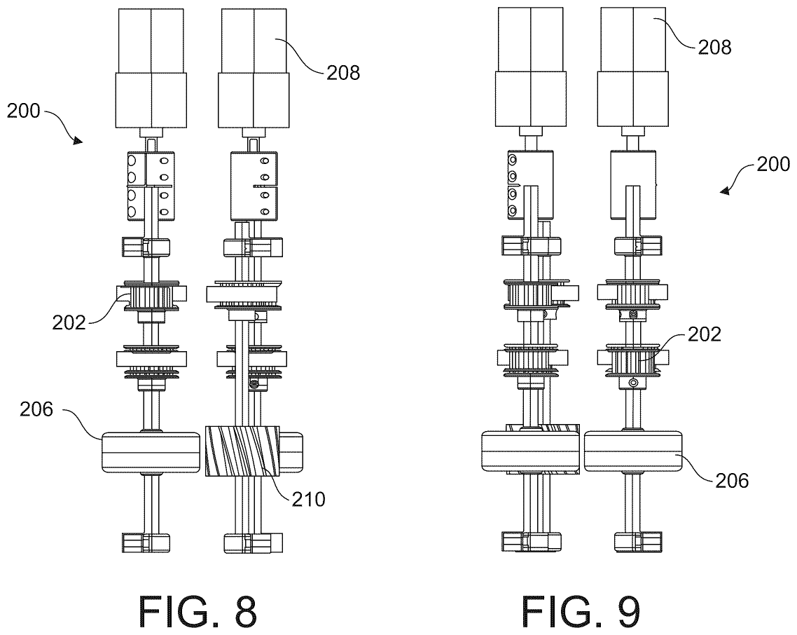

FIG. 8 illustrates a top plan view of the roller assembly 200 of FIG. 4 according to the same embodiment shown in FIGS. 4-7. The top plan view reveals the belt 204 routing across the horizontal plane and demonstrates the mechanical connections between motors 208 and driven components.

The top plan view shows the belts 204 extending between toothed pulleys 202 in parallel and perpendicular orientations, creating a network of mechanical linkages that distribute rotational motion from input sources to output components. The belt 204 paths visible from above demonstrate the routing that avoids interference between adjacent stages while maintaining proper tension for positive engagement with pulley 202 teeth. The gear alignment member 210 positioning in the top view shows its alignment with the nail channel assembly path, ensuring nail coils advancing from the rotary holding shaft 104 encounter the helical teeth at the proper angle for alignment correction.

The motors 208 appear in the top plan view connected to toothed pulleys 202 through direct shaft couplings. The motor 208 positioning at the ends of the assembly 200 enables rotational input to transmit through the belt 204 network to all processing stages without motors 208 obstructing the nail coil processing path.

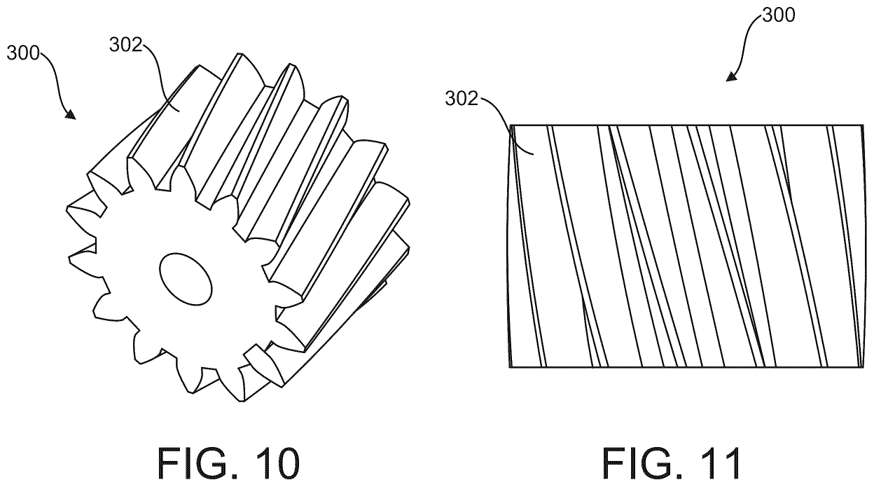

FIG. 9 illustrates a bottom plan view of the roller assembly 200 of FIG. 4 according to the same embodiment shown in FIGS. 4-8. The bottom plan view reveals the lower surface components and demonstrates the belt 204 engagement with toothed pulleys 202 on the underside of the assembly 200.

The bottom plan view shows additional toothed pulleys 202 and belts 204 positioned below the primary processing plane, extending the drive system across three dimensions to ensure all rollers 206 receive synchronized rotational input. The underside belt 204 routing complements the upper belt 204 paths visible in FIG. 8, creating a comprehensive drive network that maintains component synchronization throughout bidirectional processing cycles. The motors 208 connections visible from the bottom demonstrate the power transmission paths that enable single motor input to drive multiple rollers 206 and the gear alignment member 210 simultaneously.

In some embodiments, the toothed pulleys 202 comprise aluminum construction with precision-machined teeth that provide consistent engagement with belt 204 teeth to minimize backlash during direction reversals. In some embodiments, the belts 204 comprise reinforced rubber with embedded tensile cords that resist stretching under high loads while maintaining flexibility for pulley 202 engagement. In some embodiments, the belts 204 comprise timing belts with tooth profiles that match toothed pulley 202 configurations to ensure positive drive without slippage.

In some embodiments, the rollers 206 comprise steel cylinders with hardened surfaces that resist wear during repeated nail coil contact. In some embodiments, the rollers 206 include elastomeric coatings that increase friction with nail surfaces to improve gripping during advancement through the assembly 200. In some embodiments, the rollers 206 in different stages have different diameters optimized for their specific functions, with larger diameter rollers 206 in straightening stages providing increased contact area for bending correction.

In some embodiments, the motors 208 comprise brushless DC electric motors with electronic speed controllers that enable precise rotational speed regulation during processing operations. In some embodiments, the motors 208 operate at rotational speeds ranging from approximately 10 revolutions per minute to approximately 100 revolutions per minute depending on nail coil size and damage severity. In some embodiments, multiple motors 208 drive different stages independently to enable speed variations between alignment correction and straightening operations.

In some embodiments, the roller assembly 200 comprises two processing stages rather than three, with the gear alignment member 210 stage providing alignment correction and a single downstream stage providing straightening. In some embodiments, the roller assembly 200 comprises four or more sequential processing stages to accommodate severely damaged nail coils requiring extensive correction. In some embodiments, the vertical spacing between stages ranges from approximately 50 millimeters to approximately 150 millimeters to accommodate different nail coil diameters.

FIG. 10 illustrates a schematic diagram of one exemplary gear alignment member 300 of the roller assembly 200 of FIG. 4. The gear alignment member 300 represents a specific embodiment that performs the functions of gear alignment member 210 described in FIGS. 4-9. The schematic diagram reveals the helical tooth configuration and geometric characteristics that enable precise nail alignment correction to original equipment manufacturer specifications.

The gear alignment member 300 comprises a cylindrical body that rotates about its longitudinal axis during processing operations. The cylindrical body provides the base structure from which helical teeth 302 extend radially outward, creating the engagement surfaces that interact with individual nails of advancing nail coils. The cylindrical body dimensions enable the gear alignment member 300 to mount within the roller assembly 200 using standard bearing or bushing connections while maintaining sufficient surface area to support the helical teeth 302 arrangement. The cylindrical configuration enables continuous rotation in both forward and reverse directions during bidirectional processing cycles without mechanical interference or binding.

The gear alignment member 300 comprises a plurality of helical teeth 302 that extend from the cylindrical body surface in a spiral pattern. The helical teeth 302 wrap around the cylindrical body at a predetermined helical angle that corresponds to the angular orientation specified by OEM standards for nail coils. The helical angle ensures that as individual nails engage with the spaces between consecutive helical teeth 302, the nails adopt the proper angular relationship relative to adjacent nails in the coil. The spiral pattern created by the helical teeth 302 enables continuous engagement with advancing nail coils, with new nails entering tooth spaces as previously processed nails exit, maintaining consistent processing action throughout the coil length.

The helical teeth 302 comprise pointed shapes that facilitate nail entry into the spaces between consecutive teeth. Each helical tooth 302 includes a proximal end adjacent to the cylindrical body that exhibits greater width than the distal end extending away from the body. The tapered configuration guides individual nails into proper positioning within tooth spaces during initial engagement, with the wider proximal end providing structural support while the narrower distal end reduces interference with nail advancement. The pointed shape prevents nail jamming during entry while maintaining sufficient tooth strength to withstand forces applied during alignment correction operations.

The helical teeth 302 position spaced apart from one another at intervals that define the spaces between consecutive teeth. The spacing intervals correspond to OEM spatial standards that specify the distance between individual nails in properly manufactured nail coils. The consistent spacing ensures that as nails enter the spaces between consecutive helical teeth 302, the nails adopt the proper distance relationship relative to adjacent nails. The spaces between consecutive teeth provide clearance sufficient to receive individual nail shafts while the helical teeth 302 maintain contact with nail heads to apply corrective angular forces.

The gear alignment member 300 functions as the helical gear member recited in the claims, providing the primary mechanism for restoring damaged nail coils to usable configurations. The helical teeth 302 engage with individual nails as rollers 206 force the nail coil against the gear alignment member 300, with the roller 206 pressure ensuring nails enter fully into the spaces between consecutive helical teeth 302. As the gear alignment member 300 rotates during nail coil advancement, the helical teeth 302 apply corrective forces that adjust both the angular orientation and spacing of individual nails. The bidirectional processing capability enables each nail to pass through the gear alignment member 300 twice, once during forward rotation and once during reverse rotation, achieving comprehensive alignment correction that restores circularity and eliminates spacing variations.

FIG. 11 illustrates a top plan view of the gear alignment member 300 of FIG. 10 according to the same embodiment shown in FIG. 10. The top plan view reveals the helical pattern created by the helical teeth 302 and demonstrates the spacing intervals between consecutive teeth across the cylindrical surface.

The top plan view shows the helical teeth 302 following spiral paths across the visible cylindrical surface, with each helical tooth 302 maintaining a consistent helical angle relative to the longitudinal axis of the cylindrical body. The helical angle visible in the top view corresponds to the predetermined OEM angular orientation for nail coils, ensuring that nails positioned within the spaces between consecutive helical teeth 302 adopt the proper angle relative to the coil axis. The consistent helical angle across all teeth 302 creates uniform alignment correction regardless of which portion of the gear alignment member 300 surface engages with particular nails during rotation.

The top plan view demonstrates the spacing intervals between consecutive helical teeth 302, with uniform distances maintained throughout the spiral pattern. The spacing intervals visible in the top view correspond to OEM spatial standards that define proper nail-to-nail distances in manufactured coils. The uniform spacing creates consistent correction forces across all nails in the coil, eliminating spacing variations that cause feeding problems in pneumatic nail guns. The spaces between consecutive helical teeth 302 provide clearance for nail shaft passage while the teeth 302 themselves contact nail heads to apply corrective positioning forces.

The helical teeth 302 arrangement visible in the top plan view shows multiple complete spiral rotations around the cylindrical body, enabling simultaneous engagement with multiple nails along the coil length. The multi-rotation configuration ensures continuous processing action as nail coils advance through the gear alignment member 300, with nails at different positions along the coil simultaneously occupying different tooth spaces. The overlapping spiral pattern maintains consistent engagement throughout the processing cycle, preventing gaps in correction coverage that could leave portions of the coil unremediated.

In some embodiments, the gear alignment member 300 comprises steel construction with hardened surfaces on the helical teeth 302 to resist wear during repeated nail engagement. In some embodiments, the gear alignment member 300 comprises aluminum construction to reduce rotational inertia while maintaining sufficient strength for alignment correction forces. In some embodiments, the helical teeth 302 include surface coatings such as chrome plating or titanium nitride that enhance wear resistance and reduce friction during nail passage.

In some embodiments, the helical angle of the helical teeth 302 ranges from approximately 15 degrees to approximately 35 degrees relative to the longitudinal axis to accommodate different OEM nail coil specifications. In some embodiments, the helical teeth 302 spacing intervals range from approximately 10 millimeters to approximately 25 millimeters to match various nail sizes and coil configurations. In some embodiments, the gear alignment member 300 diameter ranges from approximately 50 millimeters to approximately 150 millimeters depending on the nail coil sizes being processed.

In some embodiments, the helical teeth 302 height measured from the cylindrical body surface to the distal end ranges from approximately 5 millimeters to approximately 15 millimeters to accommodate different nail head sizes. In some embodiments, the proximal end width of the helical teeth 302 measures approximately twice the distal end width to provide optimal nail guidance while maintaining tooth strength. In some embodiments, the gear alignment member 300 includes multiple interchangeable configurations with different helical angles and spacing intervals to enable processing of various OEM nail coil types without equipment changes.

In some embodiments, the gear alignment member 300 surface includes low-friction coatings or polished finishes between the helical teeth 302 to reduce drag forces on advancing nail coils. In some embodiments, the cylindrical body includes mounting features at its ends that enable secure attachment to rotational bearings within the roller assembly 200 while permitting free rotation during processing operations. In some embodiments, the gear alignment member 300 connects to the belt 204 and pulley 202 drive system through direct shaft coupling or gear reduction mechanisms that optimize rotational speed for alignment correction.

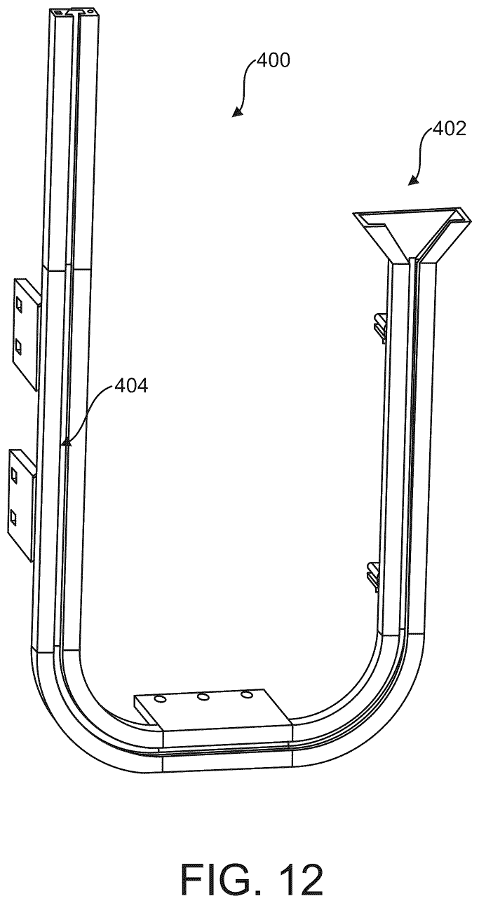

FIG. 12 illustrates a schematic diagram of one exemplary nail channel assembly 400 of the nail coil remediation system 100 of FIG. 1. The nail channel assembly 400 represents a specific embodiment that performs the functions of nail channel assembly 108 described in FIGS. 1-3. The schematic diagram reveals the opening and slot configuration that enables controlled nail coil guidance while constraining nail positioning for uniform processing.

The nail channel assembly 400 comprises an elongated body that extends along a curved path between the rotary holding shaft 104 and the roller assembly 200. The elongated body provides structural support for the opening 402 and slot 404 features while maintaining sufficient rigidity to resist deformation under forces applied by advancing nail coils. The curved configuration accommodates the transition from the cylindrical mounting surface of the rotary holding shaft 104 to the linear processing path through the roller assembly 200, enabling smooth nail coil advancement without binding or jamming. The elongated body may comprise a unitary construction formed through extrusion, casting, or fabrication processes, or may comprise multiple segments joined to create the complete channel assembly 400 length.

The nail channel assembly 400 comprises an opening 402 that forms the entrance for nail coils transitioning from the rotary holding shaft 104 into the channel assembly 400. The opening 402 exhibits a width substantially greater than the slot 404 width to accommodate nail coils in their wound configuration as they begin unwinding from the rotary holding shaft 104. The opening 402 dimensions enable nail heads, nail shafts, and connecting wires between nails to pass through simultaneously during initial entry, reducing entry resistance and preventing nail coil jamming at the channel assembly 400 entrance. The opening 402 may include flared or chamfered edges that guide nail coils smoothly into the channel assembly 400 interior during both forward and reverse processing directions.

The nail channel assembly 400 further comprises a slot 404 that extends along the elongated body length to guide nail coils toward the roller assembly 200. The slot 404 exhibits a width substantially narrower than the opening 402 width, creating a dimensional transition that constrains nail positioning as coils advance through the channel assembly 400. The slot 404 width enables nail heads to pass through while preventing nail shafts from entering, ensuring that only nail heads occupy the slot 404 during advancement. The head-constraining function provided by the slot 404 aligns all nail heads into a common plane parallel to the slot 404 orientation, eliminating variations in nail positioning that could prevent uniform engagement with the helical teeth 302 of the gear alignment member 300.

The opening 402 and slot 404 work collectively to provide controlled nail coil guidance with progressive positioning constraint. The opening 402 receives nail coils from the rotary holding shaft 104 without dimensional restrictions that could impede entry, while the slot 404 downstream from the opening 402 applies selective constraint that permits only nail head passage. The transition from the wide opening 402 to the narrow slot 404 occurs gradually along the channel assembly 400 length, enabling nail coils to adjust positioning naturally as they advance rather than encountering abrupt dimensional changes that could cause jamming. The configuration ensures consistent nail head alignment throughout the roller assembly 200 processing stages, maximizing alignment correction effectiveness.

The nail channel assembly 400 functions to maintain nail coil orientation during bidirectional processing through the roller assembly 200. During forward processing when the rotary holding shaft 104 rotates to unwind nail coils, the channel assembly 400 guides advancing nails through the opening 402 into the slot 404, with nail heads passing through the slot 404 while shafts remain below the slot 404 plane. During reverse processing when the rotary holding shaft 104 rotates to rewind nail coils, the channel assembly 400 guides returning nails back through the slot 404 toward the opening 402, maintaining head alignment throughout the reverse passage. The bidirectional guidance capability enables the channel assembly 400 to support the twice-through processing approach recited in the claims.

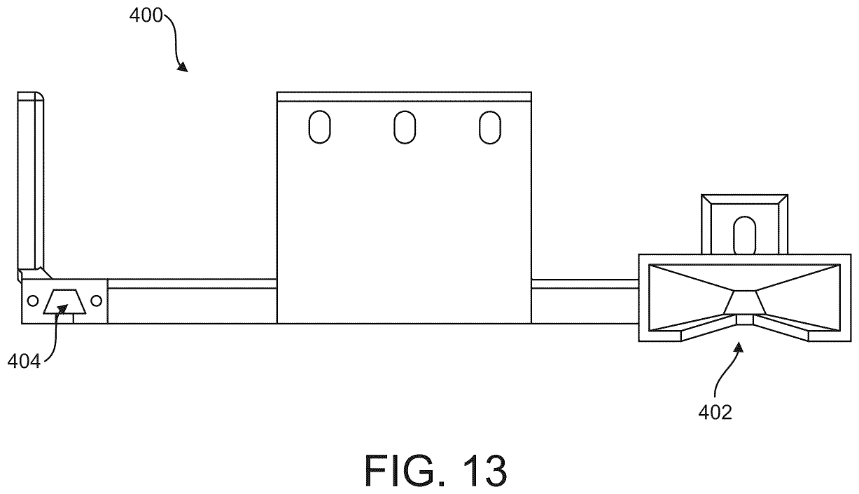

FIG. 13 illustrates a top plan view of the nail channel assembly 400 of FIG. 12 according to the same embodiment shown in FIG. 12. The top plan view reveals the opening 402 configuration and demonstrates the transition region between the opening 402 and the slot 404.

The top plan view shows the opening 402 forming a flared entrance with its widest dimension at the end closest to the rotary holding shaft 104 mounting location. The flared configuration visible in the top view provides increased clearance for nail coils entering from various angles as the rotary holding shaft 104 rotates, accommodating variations in coil positioning that occur during unwinding operations. The opening 402 width gradually decreases along the channel assembly 400 length as it transitions toward the slot 404 region, creating a funnel effect that progressively constrains nail coil positioning without abrupt dimensional changes.

The top plan view demonstrates the slot 404 extending along the channel assembly 400 length with consistent width maintained throughout the processing region. The uniform slot 404 width visible from above ensures consistent head-constraining action across all nails in the coil, preventing some nails from receiving greater constraint than others. The slot 404 positioning in the top view shows its alignment with the gear alignment member 300 location within the roller assembly 200, ensuring nail heads constrained by the slot 404 engage properly with the spaces between consecutive helical teeth 302.

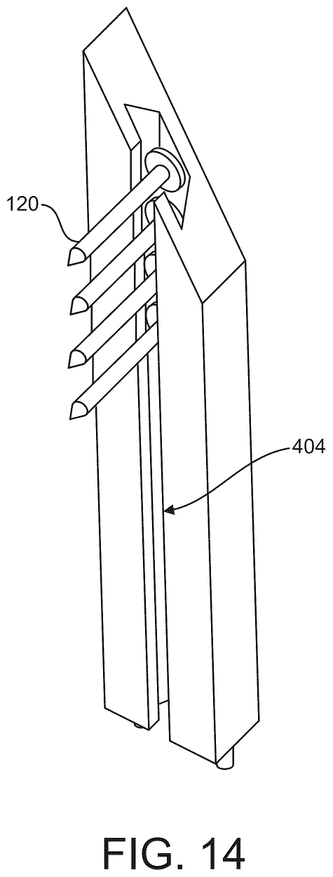

FIG. 14 illustrates a cross-sectional view of a portion of the nail channel assembly 400 of FIG. 12, shown with a portion of a nail coil 120 passing through the slot 404. The cross-sectional view reveals the head-constraining function and demonstrates how the slot 404 dimensions selectively permit nail head passage while preventing shaft entry.

The cross-sectional view shows the nail coil 120 comprising a plurality of individual nails connected together by wires or clips, with each nail including a head and a shaft extending from the head. The nail heads of the nail coil 120 position within the slot 404, with the heads passing through the slot 404 opening during advancement. The nail shafts of the nail coil 120 position below the slot 404 plane, unable to enter the slot 404 due to the dimensional constraint imposed by the slot 404 width. The selective passage configuration ensures all nail heads maintain alignment within the slot 404 plane while shafts extend downward in consistent orientation.

The cross-sectional view demonstrates the slot 404 width dimensioned to accommodate nail head diameters while excluding nail shaft diameters and wire connections between nails. The dimensional relationship visible in the cross-section shows nail heads fitting within the slot 404 with minimal clearance, preventing heads from tilting or rotating during passage while still enabling smooth advancement without excessive friction. The shaft exclusion provided by the narrow slot 404 width forces all shafts to extend downward from their respective heads, creating the uniform processing orientation required for effective engagement with the helical teeth 302 of the gear alignment member 300.

The nail coil 120 positioning in the cross-sectional view shows multiple consecutive nails simultaneously occupying different positions along the slot 404 length, with heads aligned in the common plane defined by the slot 404 and shafts extending parallel to one another below the slot 404. The parallel shaft orientation eliminates tangling that could occur if shafts crossed or interfered with one another during advancement. The head alignment in the common plane ensures that when the nail coil 120 engages with the gear alignment member 300, all nails encounter the helical teeth 302 at the same relative angle and position, maximizing correction effectiveness.

In some embodiments, the nail channel assembly 400 comprises low-friction polymer materials including polytetrafluoroethylene, ultra-high-molecular-weight polyethylene, or acetal copolymer that reduce drag forces on advancing nail coils. In some embodiments, the nail channel assembly 400 comprises metal construction with polished interior surfaces that provide durable low-friction characteristics suitable for high-volume processing operations. In some embodiments, the interior surfaces of the nail channel assembly 400 include lubricating coatings or surface treatments that further reduce friction during bidirectional nail coil passage.

In some embodiments, the opening 402 width ranges from approximately 20 millimeters to approximately 50 millimeters to accommodate various nail coil wound diameters. In some embodiments, the slot 404 width ranges from approximately 3 millimeters to approximately 8 millimeters to accommodate different nail head sizes while excluding nail shafts. In some embodiments, the transition length between the opening 402 and the slot 404 ranges from approximately 50 millimeters to approximately 150 millimeters to provide gradual dimensional constraint without jamming.

In some embodiments, the nail channel assembly 400 includes mounting brackets or attachment features that secure the assembly 400 to the frame 102 while maintaining proper alignment with the rotary holding shaft 104 and roller assembly 200. In some embodiments, the nail channel assembly 400 comprises modular sections that enable disassembly for cleaning or maintenance operations. In some embodiments, the nail channel assembly 400 includes inspection ports or transparent sections that enable visual monitoring of nail coil advancement during processing operations.

In some embodiments, the slot 404 edges include radiused or chamfered profiles that prevent sharp edges from contacting nail heads during passage, reducing wear on both the channel assembly 400 and the nail coil 120. In some embodiments, the nail channel assembly 400 curvature radius ranges from approximately 100 millimeters to approximately 300 millimeters to accommodate the transition from the rotary holding shaft 104 to the roller assembly 200 without excessive bending forces on nail coils.

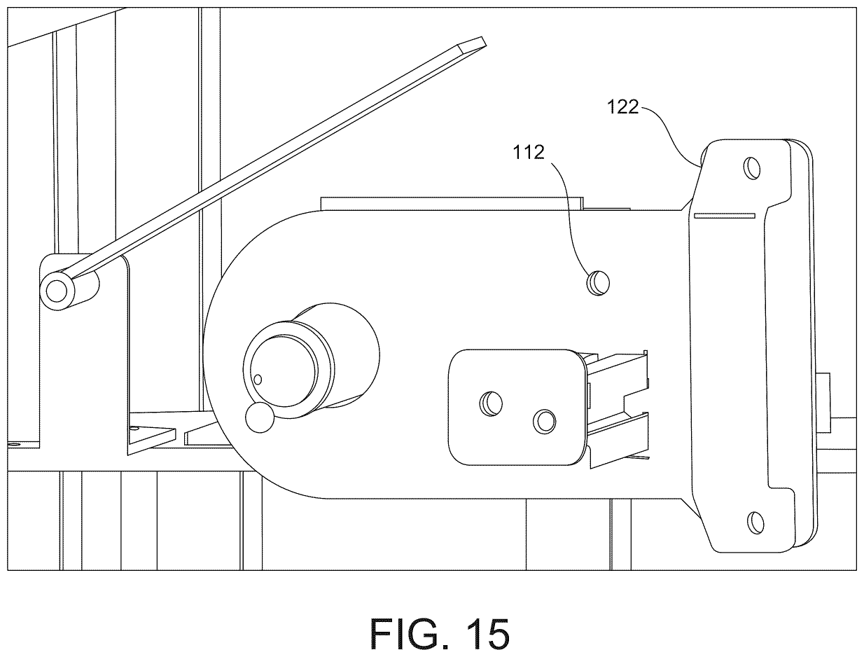

FIG. 15 illustrates a schematic diagram of a portion of the nail coil remediation system 100 of FIG. 1, showing an enlarged view of the nail coil removal plate 110. The enlarged view reveals the handle 122 and opening 112 configuration that enables convenient nail coil removal from the rotary holding shaft 104 after remediation operations complete.

The removal plate 110 comprises a planar member that positions on the rotary holding shaft 104 to support wound nail coils during processing operations. The planar member provides a flat surface beneath the nail coil that prevents the coil from sliding along the rotary holding shaft 104 during rotation while maintaining proper coil positioning for uniform unwinding. The planar member extends radially outward from the rotary holding shaft 104 with sufficient diameter to support nail coil wound diameters encountered in construction applications, typically ranging from approximately 50 millimeters to approximately 200 millimeters. The planar configuration enables the removal plate 110 to slide along the rotary holding shaft 104 length during loading and removal operations while providing stable support during processing.

The removal plate 110 comprises an opening 112 that extends through the planar member to receive the rotary holding shaft 104. The opening 112 dimensions provide clearance for the rotary holding shaft 104 diameter while maintaining sufficient engagement to prevent excessive play or wobbling during rotation. The opening 112 positioning in the center of the planar member ensures balanced support for nail coils positioned symmetrically around the rotary holding shaft 104. The through-hole configuration of the opening 112 enables the removal plate 110 to slide freely along the rotary holding shaft 104 length during installation and removal operations, with the shaft 104 extending completely through the opening 112 to maintain the plate 110 in proper axial position.

The removal plate 110 further comprises a handle 122 that extends from the planar member to provide gripping surfaces for manual manipulation. The handle 122 positions at the edge or upper surface of the planar member, enabling users to grasp the handle 122 and pull the removal plate 110 along the rotary holding shaft 104 to extract remediated nail coils. The handle 122 configuration provides ergonomic gripping characteristics that enable secure grasp with one hand while the other hand steadies the apparatus 100 or manages the removed coil. The handle 122 positioning above or adjacent to the planar member maintains clearance from the frame 102 components during removal operations, preventing interference that could impede plate 110 movement along the shaft 104.

The removal plate 110 functions to simplify nail coil loading and removal operations during sequential processing of multiple damaged coils. During loading operations, users slide the removal plate 110 onto the rotary holding shaft 104 from one end, position the plate 110 at a desired location along the shaft 104, then mount a damaged nail coil around the shaft 104 with the coil resting on the planar member surface. During removal operations after remediation completes and the nail coil has rewound onto the rotary holding shaft 104, users grasp the handle 122 and pull the removal plate 110 along the shaft 104, with the rewound coil moving with the plate 110 until the coil slides off the shaft 104 end. The removal plate has an integrated stop that prevents the removal plate from sliding of the rail it is mounted to, placed at a location that stops movement of the removal plate once the nail coil is fully removed from the rotary holding shaft. The removal system evenly pulls the remediated coils from the shaft 104, reducing handling time and preventing damage to the corrected nail alignment.

The opening 112, planar member, and handle 122 work collectively to provide efficient coil management throughout the remediation process. The opening 112 is dimensioned with minimal clearance relative to the rotary holding shaft 104 diameter, with the opening 112 sized only slightly larger than the shaft 104 to enable even force distribution across the nail coil during removal operations. The tight-fitting relationship ensures that pulling forces applied to the handle 122 transfer uniformly to the wound coil, preventing uneven loading that could damage remediated nail alignment. The removal plate 110 does not contact the rotary holding shaft 104 during operation, but instead slides along an aluminum extrusion rail positioned between the opening 112 and the handle 122. The rail provides the guided movement path that enables the plate 110 to slide smoothly during installation and removal operations while the opening 112 maintains clearance around the shaft 104. The planar member provides the support surface that maintains coil positioning during bidirectional processing through the roller assembly 200 and nail channel assembly 400. The handle 122 provides the gripping interface that enables convenient manual manipulation without requiring tools or complex procedures. The integrated configuration reduces the time required for sequential coil processing, improving operational efficiency during high-volume remediation operations.

In some embodiments, the removal plate 110 comprises steel construction that provides sufficient strength to support nail coil weights during rotation without bending or deformation. In some embodiments, the removal plate 110 comprises aluminum construction that reduces weight for easier handling during removal operations. In some embodiments, the removal plate 110 comprises polymer materials that reduce cost while maintaining adequate strength for typical construction-grade nail coils.

In some embodiments, the opening 112 diameter ranges from approximately 15 millimeters to approximately 40 millimeters to accommodate various rotary holding shaft 104 diameters. In some embodiments, the aluminum extrusion rail includes low-friction bearing surfaces that enable smooth sliding of the removal plate 110 during installation and removal operations. In some embodiments, the planar member diameter ranges from approximately 75 millimeters to approximately 250 millimeters to support various nail coil sizes.

In some embodiments, the handle 122 comprises a molded grip with ergonomic contours that improve user comfort during pulling operations. In some embodiments, the handle 122 comprises a loop or strap configuration that enables finger insertion for secure grasping.

In some embodiments, the removal plate 110 includes markings or indicators on the planar member surface that show proper coil positioning or alignment references during loading operations. In some embodiments, multiple removal plates 110 of different sizes accommodate various nail coil diameters encountered in different construction applications.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A nail coil remediation apparatus, comprising:
(a) a rotary holding shaft configured to support a nail coil and to rotate bidirectionally to selectively unwind and rewind the nail coil;
(b) a nail channel assembly comprising a slot, wherein the slot is configured to receive and guide a plurality of heads of a plurality of individual nails of the nail coil therethrough;
(c) a helical gear member positioned adjacent to the slot of the nail channel assembly, wherein the helical gear member comprises a plurality of helical teeth spaced apart from one another to define spaces configured to receive the plurality of individual nails of the nail coil between adjacent helical teeth; and
(d) a first roller positioned relative to the helical gear member, wherein the first roller is configured to force the plurality of individual nails of the nail coil into the spaces between the adjacent helical teeth as the nail coil passes between the first roller and the helical gear member;
wherein the rotary holding shaft is configured to rotate in a first direction to unwind the nail coil and advance the nail coil through the slot and between the first roller and the helical gear member, and wherein the rotary holding shaft is further configured to rotate in a second direction opposite the first direction to pass the nail coil back between the first roller and the helical gear member and rewind the nail coil onto the rotary holding shaft.

2. The nail coil remediation apparatus of claim 1, wherein the nail coil passes between the first roller and the helical gear member twice to remediate alignment of the plurality of individual nails.

3. The nail coil remediation apparatus of claim 1, wherein the rotary holding shaft comprises a magnetic material configured to secure the nail coil to the rotary holding shaft during unwinding and rewinding.

4. The nail coil remediation apparatus of claim 1, wherein the plurality of helical teeth of the helical gear member are arranged at a helical angle configured to correspond to an original equipment manufacturer angular orientation for the plurality of individual nails in the nail coil.

5. The nail coil remediation apparatus of claim 1, wherein the plurality of helical teeth of the helical gear member are spaced apart at intervals consistent with an original equipment manufacturer spacing standard for the nail coil.

6. The nail coil remediation apparatus of claim 1, wherein each helical tooth of the plurality of helical teeth comprises a pointed shape having a proximal end and a distal end, wherein the proximal end is wider than the distal end.

7. The nail coil remediation apparatus of claim 1, wherein the nail channel assembly comprises a low-friction material configured to enable the nail coil to translate therethrough.

8. The nail coil remediation apparatus of claim 1, wherein the nail channel assembly further comprises an opening configured to receive the nail coil from the rotary holding shaft, wherein the slot is narrower than the opening.

9. The nail coil remediation apparatus of claim 1, wherein the slot is dimensioned to receive the plurality of heads of the plurality of individual nails while preventing shafts of the plurality of individual nails from entering the slot to ensure uniform processing of the plurality of individual nails.

10. The nail coil remediation apparatus of claim 1, further comprising a frame configured to support the rotary holding shaft, the nail channel assembly, the helical gear member, and the first roller.

11. The nail coil remediation apparatus of claim 1, further comprising at least one motor operatively connected to the first roller, wherein the at least one motor is configured to drive rotation of the first roller.

12. The nail coil remediation apparatus of claim 1, wherein the first roller and the helical gear member together form an aligning stage configured to adjust alignment of the plurality of individual nails as the nail coil passes therebetween.

13. The nail coil remediation apparatus of claim 12, further comprising a straightening stage positioned downstream of the aligning stage, wherein the straightening stage comprises a second roller configured to further adjust alignment of the plurality of individual nails after the plurality of individual nails pass through the aligning stage.

14. A nail coil remediation apparatus, comprising:
(a) a frame configured to support and house components of the system;
(b) a rotary holding shaft supported by the frame, wherein the rotary holding shaft is configured to support the nail coil and to rotate to unwind and rewind the nail coil;
(c) a nail channel assembly supported by the frame, wherein the nail channel assembly is configured to receive the nail coil from the rotary holding shaft and guide the nail coil therethrough;
(d) a roller assembly supported by the frame and positioned adjacent to the nail channel assembly, wherein the roller assembly comprises:
(i) a gear member comprising a plurality of teeth defining spaces therebetween configured to receive individual nails of the nail coil; and
(ii) at least one roller positioned relative to the gear member, wherein the nail coil passes between the at least one roller and the gear member, wherein the at least one roller is configured to guide the individual nails of the nail coil into the spaces of the gear member; and
(e) at least one motor operatively connected to the roller assembly, wherein the at least one motor is configured to drive the roller assembly;
wherein the rotary holding shaft is configured to rotate bidirectionally to pass the nail coil through the roller assembly in a first direction and a second direction to remediate alignment of the individual nails of the nail coil.

15. The nail coil remediation system of claim 14, wherein the gear member comprises a helical gear member having a plurality of helical teeth arranged at a helical angle corresponding to an original equipment manufacturer angular orientation for the individual nails of the nail coil.

16. The nail coil remediation system of claim 14, wherein the roller assembly further comprises a plurality of toothed pulleys and a plurality of belts operatively connecting the at least one roller to the at least one motor.

17. The nail coil remediation system of claim 14, wherein the nail channel assembly comprises a slot configured to receive a plurality of heads of a plurality of individual nails of the nail coil while preventing shafts of the plurality of individual nails from entering the slot.

18. A nail coil remediation device, comprising:
(a) a shaft configured to receive a nail coil thereon;
(b) a channel comprising a slot configured to guide the nail coil;
(c) a gear alignment member positioned adjacent to the slot, wherein the gear alignment member comprises a plurality of teeth spaced apart from one another at intervals, wherein the intervals define spaces between consecutive teeth of the plurality of teeth, wherein each space is dimensioned to receive an individual nail of the nail coil, wherein the plurality of teeth are configured to adjust alignment of individual nails of the nail coil; and
(d) a roller positioned to engage the nail coil, wherein the roller is configured to force the individual nails of the nail coil into the spaces between the consecutive teeth as the nail coil is advanced through the channel;
wherein the shaft is configured to rotate to advance the nail coil past the gear alignment member to remediate the nail coil.

19. The nail coil remediation device of claim 18, wherein the plurality of teeth comprise helical teeth arranged at a helical angle, wherein the helical teeth are spaced apart at intervals corresponding to an original equipment manufacturer spacing standard for the nail coil.

20. The nail coil remediation device of claim 18, further comprising a removal plate having an opening therethrough, wherein the shaft extends through the opening of the removal plate, wherein the removal plate is configured to enable removal of the nail coil from the shaft after the nail coil has been remediated.
